(19) United States
(12) Patent Application Publication
(10) Pub. No.: US 2006/0220586 A1
(43) Pub. Date: Oct. 5, 2006

(54) Array of light emitting diodes

(76) Inventor: Christopher Brian Latham, Orchard Cottage (GB)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/099,215

(22) Filed: Apr. 5, 2005

(51) Int. Cl. H05B 37/00

(52) U.S. Cl. 315/185 S

(57) ABSTRACT

The invention concerns LED arrays of the type in which one or more “strings” of LEDs such as 6 are series connected across a potential difference as at 8, 10. To compensate for changes in forward voltage of individual LEDs 4, and/or for supply voltage variations, a switching means (which may be formed as a transistor T2, T3) is provided for selectively removing one or more LEDs from the strings. This can for example be done by selectively shorting the chosen LEDs.

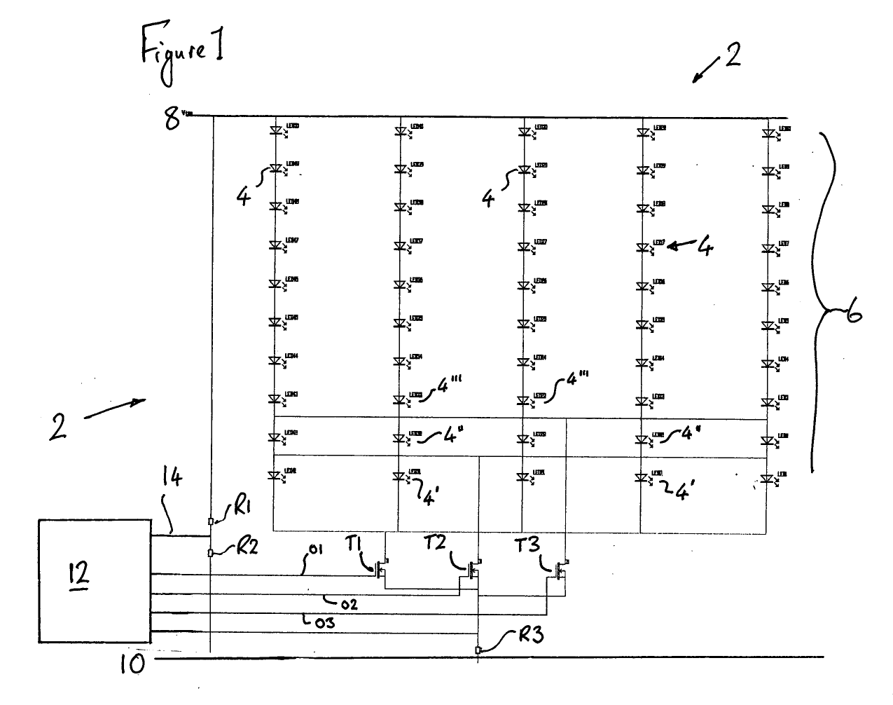

The present invention relates to LED arrays.

It is a common practice to arrange a set of LEDs in some form of array, in order to provide a required level of total optical power. For example bulbs or lamps using LEDs have in recent years been adopted as replacements for more traditional light sources such as incandescent bulbs. An array of several LEDs is typically needed to provide illumination equivalent to that of one conventional bulb. The LEDs are typically placed side-by-side upon some form of carrier such as a printed circuit board. An early example of an LED “bulb” constructed in this manner is found in FR 2586844 (Sofrela) but such devices are by now very widely known.

In designing an LED array to be driven from a supply with a given voltage, the necessary number of LEDs is typically split between a set of series-connected “strings” of LEDs, each string being connected across the supply. The number of LEDs in a string is chosen such that their total forward voltage is slightly lower than the supply voltage. For example in an array to be run from a 28V DC supply, the string length could be chosen to give a 26 V forward voltage across the string, e.g. by using 10 LEDs each with a forward voltage (V_{f}) of 2.6. This arrangement permits power loss in an associated LED driver/control circuit to be kept low whilst effecting enough control to protect the LEDs from overcurrent and enabling intensity reduction if required.

Problems arise, however, if the LED array is required to work over a range of temperatures and supply voltages, particularly if it is also necessary to meet a tight specification concerning the array's light output. The present invention was devised in connection with lights for use at the exterior of an aircraft, which is a particularly demanding environment in these respects, although it is applicable in other fields.

Temperature variations are problematic because LED forward voltage V_{f} is temperature dependent. Specifically, V_{f} increases as temperature reduces. In the example given above, if ambient temperature is reduced from 25° C. to −40° C. the string's forward voltage would increase from 26V to 28.8V, exceeding the supply. This range of operating temperatures is not excessive for military and aeronautical applications. The result could be that at extremely low temperatures so little current would pass that the LEDs would not illuminate at all, and at more moderate low temperatures LED output would be very low.

Supply voltage variations can also prevent the LED array from operating correctly given that the minimum voltage of a nominal 28V supply array may be 22V or even less.

One way to address such problems is to select the length of the LED strings to give acceptable performance at the lower temperatures and voltages. In the example above this might mean using a string with a forward voltage of 22V at room temperature. However this results in excess power dissipation at room temperature and normal voltage. Higher power must therefore be dissipated, typically necessitating use of a large and heavy heat sink. The problem is exacerbated by the fact that as the temperature rises the LED efficiency falls, creating a vicious circle.

Another way to address the above problems is to use some form of switched mode power supply, which can generate different voltages with very high efficiency and thus match the LED's optimum drive voltage over ranges of temperature and supply voltage. However such supplies are complex but worse—and often crucially—they generate electromagnetic interference which makes them unacceptable e.g. in many aerospace applications.

European patent application 1006506 (Hewlett-Packard Company) concerns an optical vehicle display having a set of LEDs arranged in a matrix. A circuit diagram is shown in which each of the LEDs is provided with a parallel-connected switch by which an LED which fails can be short-circuited enabling the remaining LEDs to continue to function. The LED matrix is driven from a current source. The problems posed by changes in LED forward voltage and supply voltage is not addressed in this document.

European patent application EP 1318701 (Audi AG) concerns a method and apparatus for driving a plurality of LEDs. The circuit includes a series-connected set of light emitting diodes, and a current source and switch connected in series with the diodes. A topped bridge across some, but not all, of the diodes contains a second current source and a second switch.

U.S. Pat. No. 6,320,322 (Rohm Co,. Ltd.) discloses an arrangement having red, green and blue LEDs. By adjusting the luminance of the three elements, a range of colours can be created. Driving circuitry for the three LEDs is disclosed, but this does not address the problems associated with changes in LED forward voltage and supply voltage.

German Grebrauchsmusterschrift 20101418 (Insta Elektro GmbH & Co. KG) concerns a switching control for multiple lighting units with a microcomputer controller, in which individual LEDs can be bridged by respective switches It is an object of the present invention to provide an improved LED array. More specifically, it is intended to provide an LED array capable of improved operation over a range of temperatures and/or supply voltages.

In accordance with the present invention, there is an array of light emitting diodes (LEDs) comprising at least one string of LEDs within which the LEDs are connected in series with one another, the string being connectable across a potential difference to drive the LEDs, and at least one switching means being provided for selectively reducing the effective length of the string by removing at least one LED from the current path through the string.

By shortening the effective length of the string, its forward voltage can be reduced. This provides a very straightforward way to compensate for changes in the forward voltage of individual LEDs and for supply voltage variability.

While the “array” in question could have just one LED string, in the more typical case it comprises a plurality of strings in parallel with one another. The strings typically all comprise the same number of LEDs.

In the preferred embodiment the switching means serves to selectively bridge at least one LED in order to effectively remove it from the string.

A further preferred embodiment comprises two or more switching means for selectively removing different LEDs or sets of LEDs from the string, providing three or more possible string lengths.

A transistor is the preferred form of switching means and has the advantage of creating no appreciable electromagnetic interference. It can also be used to regulate LED current.

Preferably, the switching means is controlled by an electronic controller responsive to one or more of (I) a measured temperature; (ii) a measured LED current; and (iii) a measured supply voltage.

A specific embodiment of the present invention will now be described, by way of example only, with reference to the accompanying drawing, which is a circuit diagram of an LED array.

The illustrated array 2 contains a total of fifty LEDs 4 arranged in five series strings 6. Of course the total number of LEDs is chosen according to requirements for optical power output. The total length of each string is chosen with reference to the intended supply voltage and the LEDs' forward voltage. The supply is connected across high rail 8 and ground 10. The strings are connected in parallel with each other.

A microprocessor/controller 12 receives, in this particular embodiment, two inputs. The first input is indicative of the supply voltage, and is obtained through a connection 14 to the mid point of a potential divider formed by two resistors R1, R2 which are connected in series across the supply. The second of the two inputs is indicative of the sum of the currents passing through the LED strings 6 and is obtained by detecting the voltage across a resistor R3 through which all of the strings are connected to ground. Based upon these two inputs, the controller selects the states of control outputs O1, O2, O3 to respective switching transistors T1, T2, T3. In this way, the controller determines the length of the LED strings.

T1 serves, when in its closed circuit or “on” state, to connect the LED 4′ at the end of each string to resistor R3 and so to ground. If T1 is on and the other transistors are “off” (open circuit) then all ten of the LEDs in each string are illuminated. If T2 is then switched on and T1 is switched off then the second LED 4″ in each string is connected to ground via T2 and R3. End LEDs 4′ are effectively disconnected and no longer illuminated. Each LED string 6 is thus shortened to contain nine illuminated LEDs. Switching on T3 and switching off T2 then connects the third LED 4′″ in each string via T3 and R3 to ground. Both end LEDs 4′ and second LEDs 4″ are then disconnected and each string contains only eight illuminated LEDs.

By adjusting string length the strings' forward voltage is correspondingly adjusted and in this way compensation is effected both for the temperature dependent changes in forward voltage of individual LEDs and for supply voltage variation.

In the specific exemplary embodiment illustrated in the drawing, shortening of the strings entails reducing the total number of LEDs which are illuminated. In the case where compensation is effected for low temperature, this need not necessarily reduce total light output, since LED efficiency is higher at low temperatures. Where compensation is being made for low supply voltage, LED current is of course increased and even if this is insufficient to maintain light output there will at least be significant intensity, which is acceptable in some programs where LED lights are replacing incandescent bulbs whose output would in any case drop to 40% of normal if supply voltage falls from 28V to 22V.

The controller 12 sets the state of transistors T1-T3, and hence the LED string length, based upon its sensor inputs. In the illustrated example this is done on the basis of supply voltage and LED current. However there are other operating parameters which could be sensed and used in setting string length. For example ambient temperature or LED operating temperature could be measured and taken account of in this regard.

A current regulating function is also carried out by whichever transistor is conducting. The microprocessor 12 monitors voltage across resistor R3, which corresponds to total LED current. In response, the microprocessor controls the conductive transistor T1, T2 or T3 and thereby regulates the current.

The LED array may of course be incorporated into any form of LED lamp, light or bulb. However the low component count makes the present invention particularly suited to use in units designed to substitute directly for incandescent bulbs (e.g. having a conventional bayonet or screw bulb fitting). The fact that no appreciable electromagnetic interference is created also makes the invention suitable for sensitive applications e.g. on aircraft.

What we claim is:

1. An array of light emitting diodes (LEDs) comprising at least one string of LEDs within which the LEDs are connected in series with one another to form a current path through the string, the string being connectable across a potential difference to drive the LEDs, the array being provided with an arrangement for controlling forward voltage of the string, comprising at least one switching device connected to the LEDs such that by switching it serves to remove at least one LED from the current path through the string.

2. An array of LEDs as claimed in claim 1 which comprises a plurality of strings in parallel with each other.

3. An array of LEDs as claimed in claim 2 wherein the switching means is connected to each string for selectively reducing the effective length of each.

4. An array of LEDs as claimed in claim 1 wherein the switching means serves to selectively bridge at least one LED in order to effectively remove it from the string.

5. An array of LEDs as claimed in claim 1 comprising at least first and second switching means, the first switching means serving when “on” to complete a circuit through the complete LED string and the second switching means serving when “on” to complete a circuit through a shortened LED string.

6. An array of LEDs as claimed in claim 5 wherein only one of the switching means is “on” at any time.

7. An array of LEDs as claimed in claim 1, comprising two or more switching means for selectively removing different LEDs or sets of LEDs from the string, providing three or more possible string lengths.

8. An array of LEDs as claimed in claim 1 wherein the switching means comprises a transistor.

9. An array of LEDs as claimed in claim 1 wherein the switching means is controlled by an electronic controller which responsive to one or more of (i) a measured temperature; (ii) a measured LED current; and (iii) said potential difference.

10. An array of LEDs as claimed in claim 8 comprising an electronic controller which senses LED current and controls it by means of the transistor.

11. An LED lamp, light or bulb comprising an array of LEDs as claimed in claim 1.

12. A method of controlling the forward voltage of a set of light emitting diodes (LEDs), comprising connecting the diodes in a series string to provide a current path through them, connecting the string of LEDs across a potential difference to cause a current to flow through them, and selectively removing at least one LED from said current path when necessary to reduce the total forward voltage of the string.

13. A method as claimed in claim 12 wherein selective removal of the at least one LED is performed as necessary to prevent the total forward voltage of the string from exceeding a supply voltage.

14. A method as claimed in claim 12, comprising monitoring at least one of (i) temperature; (ii) LED current; and (iii) said potential difference, and controlling said selective removal of at least one LED in dependence upon said monitoring.

15. A method as claimed in claim 12, comprising removing said at least one LED from the string in response to a fall in the potential difference applied across the string.

16. A method as claimed in claim 12, comprising removing said at least one LED from the string in response to a fall in current through the LEDs.

17. A method as claimed in claim 12, which comprises connecting a plurality of strings in parallel with each other across the potential difference, and wherein said selective removal involves concurrently removing at least one LED from each of said strings.
